(19) United States
(12) Patent Application Publication
(10) Pub. No.: US 2013/0134174 A1
(43) Pub. Date: May 30, 2013

(54) FOOD AND/OR DRINK CONTAINER WITH ATTACHABLE BODY PARTS AND/OR FACIAL FEATURES AND METHOD OF MAKING AND USING THE SAME

(71) Applicants: Aram Clinton TESSIER, Coventry, RI (US); Robert GLUCK, Lawrence, NY (US)

(72) Inventors: Aram Clinton TESSIER, Coventry, RI (US); Robert GLUCK, Lawrence, NY (US)

(73) Assignee: Robert Gluck, Lawrence, NY (US)

(21) Appl. No.: 13/364,886

(22) Filed: Feb. 2, 2012

Related U.S. Application Data
(60) Provisional application No. 61/564,629, filed on Nov. 29, 2011.

(51) Int. Cl. B65D 25/20; B23P 11/00

(52) U.S. Cl. 220/694; 29/428

(57) ABSTRACT

The invention provides for a food or beverage container comprising a container body sized to contain therein an edible substance or drinkable substance. At least one element (or image thereof) is attachable to the body (or any part thereof) of the container.

### CROSS-REFERENCE TO RELATED APPLICATIONS

The instant application is a US non-provisional Application based on U.S. provisional application No. 61/564,629, filed Nov. 29, 2011, the disclosure of which is hereby expressly incorporated by reference hereto in its entirety.

### BACKGROUND OF THE INVENTION

1. Field of the Invention

The invention relates to a food or drink container to which one or more elements, body parts or facial features can be attached as shown in the drawings and/or recited in the claims. A method of making and using the container is also disclosed as is a method of decorating the container with such parts/features.

2. Discussion of Background Information

Food and drink containers are well known. Such devices are disclosed in, e.g. US D465,973, U.S. Pat. No. 7,540,833, U.S. Pat. No. 6,145,553, as well as numerous US patents issued to the company Robert Gordon Industries, LTD such as U.S. Pat. No. 7,556,425, US D575,103 and US D563,723. These and other documents listed in the above-noted US provisional application and/or assigned to Robert Gordon Industries, LTD are herein expressly incorporated by reference in their entireties as though set forth in full.

An improved container, however, would allow a user to attached or decorate one or more of such containers with elements, body parts, facial features, pictures or representations of such, etc., whether inanimate, human, animal, insect or other living thing.

It is submitted that there is a need for such a container and which is lacking in known devices.

### SUMMARY OF THE INVENTION

In accordance with one non-limiting embodiment, there is provided a food or beverage container comprising a container body sized to contain therein an edible substance and at least one of; at least one three-dimensional element attachable to the body of the container, at least one image of an object attachable to the body of the container, at least one image of a facial feature attachable to the body of the container, at least one image of body part attachable to the body of the container, at least one body part attachable to the body of the container, at least one body part removably attachable to the body of the container, at least one facial feature attachable to the body of the container, and at least one facial feature removably attachable to the body of the container.

In accordance with one non-limiting embodiment, there is provided a food or beverage container comprising a container body sized to contain therein an edible substance or drinkable substance and at least one of; at least one body part attachable to the body of the container, at least one body part removably attachable to the body of the container, at least one facial feature attachable to the body of the container, and at least one facial feature removably attachable to the body of the container.

In embodiments, the container is one of; a cup, a can, a drink vessel, a mug, and a conventionally known container that can contain an edible drinking substance.

In embodiments, the container is one of; a food bowl, a soup bowl, a cereal bowl, and a conventionally know container that can contain an edible eating substance.

In embodiments, the at least one body part is one of; an arm, a hand, a finger, a leg, a foot, a toe, and at least one portion of any of the above.

In embodiments, the at least one facial feature is one of; an eye, eyes, a nose, an ear, ears, a mouth, and at least one portion of any of the above.

In embodiments, the at least one body part is attachable via one of; a snap connection, a projection insertable into an opening, and a magnet.

In embodiments, the at least one facial feature is attachable via one of; a snap connection, a projection insertable into an opening, a magnetic, a releasable connection, and a lockable connection.

In accordance with another non-limiting embodiment, there is provided a container comprising a container body sized to contain therein an edible substance and plural body parts attachable to the body of the container, wherein, once attached, the container at least partially resembles a living thing.

In accordance with another non-limiting embodiment, there is provided a container comprising a container body sized to contain therein an edible substance and plural facial features attachable to the body of the container, wherein, once attached, the container at least partially resembles a living thing.

In accordance with another non-limiting embodiment, there is provided a method of decorating the container of any one of the type described above, wherein the method comprises attaching at least one body part or facial feature to the body of the container.

In accordance with another non-limiting embodiment, there is provided a method of decorating the container of any one of the type described above, wherein the method comprises removably attaching at least one body part or facial feature to the body of the container.

In accordance with another non-limiting embodiment, there is provided a method of decorating the container of any one of the type described above, wherein the method comprises attaching at least one body part or facial feature to the body of the container and attaching at least one other body part or facial feature to the body of the container.

In accordance with another non-limiting embodiment, there is provided a method of decorating the container of any one of the type described above, wherein the method comprises removably attaching at least one body part or facial feature to the body of the container and removably attaching at least one other body part or facial feature to the body of the container.

In accordance with another non-limiting embodiment, there is provided a method of decorating the container of any one of the type described above, wherein the method comprises removing at least one body part or facial feature to the body of the container and attaching at least one different body part or facial feature to the body of the container.

In accordance with another non-limiting embodiment, there is provided a method of decorating the container of any one of the type described above, wherein the method comprises at least one of; forming a container body to which at least one body part or facial feature can be attached, manufacturing a container body to which at least one body part or facial feature can be attached, and arranging at least one connecting arrangement on a container body to which at least one body part or facial feature can be attached.

In embodiments, the assembled container resembles one of; a human, a child, a dog, a cat, a cow, an insect, a mammal, a bird, an amphibian, a lizard, any animal that is living on earth in the year 2011, and any extinct animal such as a dinosaur.

In embodiments, the assembled container can be customized with attachable objects such as numbers, letters, or other three-dimensional attachable elements.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a side view of an undecorated container in accordance with one embodiment of the invention;

FIG. 2 shows a top view of FIG. 1;

FIG. 3 shows a side partial cross-section view of FIG. 1 rotated 90 degrees and shows a cover in cross-section;

FIG. 4 shows a side view of FIG. 1 as two oppositely arranged ear-shaped elements are in the process of being attached to the container;

FIG. 5 shows a side view of an eyes-shaped attachable element;

FIG. 6 shows a top view of FIG. 5;

FIG. 7 shows a top view of a nose-shaped attachable element;

FIG. 8 shows a top view of a mouth-shaped attachable element;

FIG. 9 shows a side view of FIG. 1 with the attachable elements shown in FIGS. 4-8 fully attached to the container;

FIG. 10 shows a side view of the container of FIG. 9 as the ear-shaped attachable elements are replaced by arm-shaped attachable elements;

FIG. 11 shows a side view of another embodiment of a container similar to that of FIG. 1 by including a handle;

FIG. 12 shows a side view of the container of FIG. 1 as fin-shaped attachable elements are being attached thereto and illustrates how the addition of a cone-shaped cover allows the container to be made to generally resemble a rocket;

FIG. 13 shows a side view of the container of FIG. 1 as a fin-shaped attachable element and a bow-shaped attachable element are being attached thereto and illustrates how the container to be made to generally resemble a boat;

FIG. 14 shows a side view of the container of FIG. 1 as a tail-shaped attachable element and a front fuselage-shaped attachable element are being attached thereto and illustrates how the container to be made to generally resemble an airplane;

FIG. 15 shows a side view of the container of FIG. 1 as an animal head-shaped attachable element and a body-shaped attachable element are being attached thereto and illustrates how the container to be made to generally resemble a pig;

FIG. 16 shows a side view of the container of FIG. 1 as a human head-shaped attachable element and a human body-shaped attachable element are being attached thereto and illustrates how the container to be made to generally resemble a person dressed in a specific or recognized way. The appearance can be augmented by the addition of a hat-shaped cover;

FIG. 17 shows a side view of the container of FIG. 10 after letter-shaped attachable elements are attached to the container to form a person's name;

FIG. 18 shows a right side view of an M-shaped attachable element;

FIG. 19 shows a top or front view of FIG. 19;

FIG. 20 shows a side view of the container similar to that of FIG. 12, but with different fin-shaped attachable elements are being attached thereto and illustrates how the addition of a cone-shaped cover and a base fin-shaped coaster allows the container to be made to even more generally resemble a rocket;

FIG. 21 shows a top view of the coaster shown in FIG. 20;

FIG. 22 shows a side view of FIG. 21;

FIG. 23 shows a side cross-section view of a portion of a container wall and illustrates a blind recess formed therein for attaching an attachable element thereto;

FIG. 24 shows a side cross-section view of a portion of a container wall and illustrates an enlarged blind recess formed therein for attaching an attachable element thereto;

FIG. 25 shows a side view of a surface of a container wall and illustrates a snap-connection system for attaching an attachable element thereto;

FIGS. 26 and 26 show side cross-section views of a container wall and illustrates a pin into expandable recess connection system for attaching an attachable element thereto;

FIGS. 28 and 29 show side cross-section views of a container wall and illustrates magnetic connection systems for attaching an attachable element thereto;

FIGS. 30 and 31 show side cross-section views of a portion of a container wall and illustrates an enlarged blind recess formed therein for receiving therein an attachable element having a two-dimensional representation of an object.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

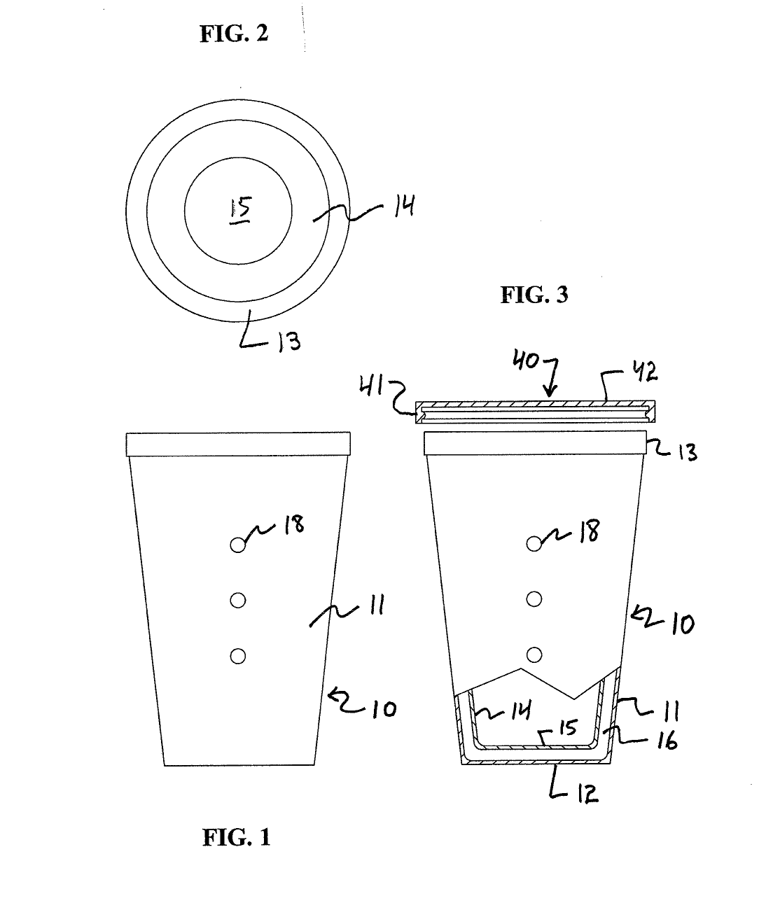

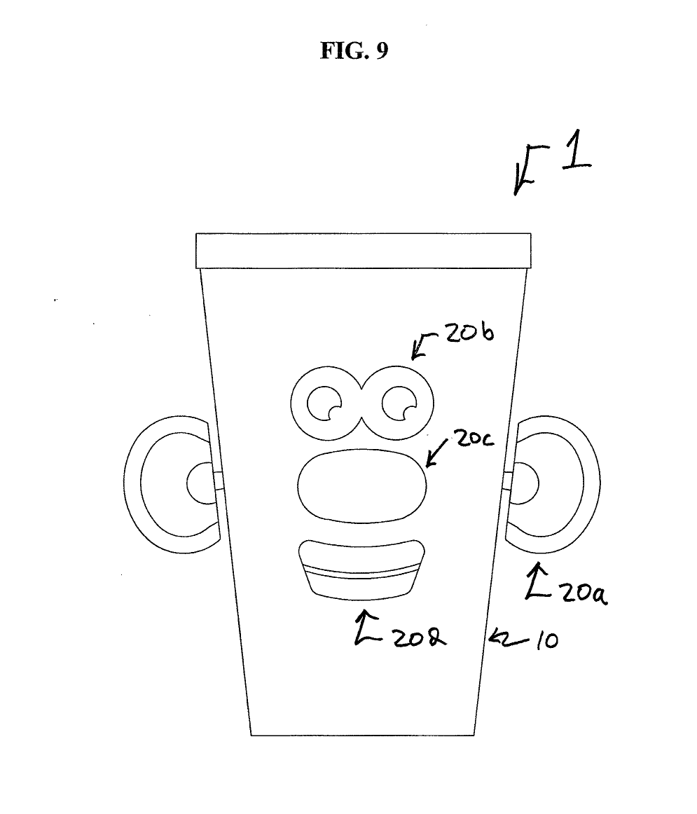

In accordance with one non-limiting embodiment, there is shown in FIGS. 1-9 a first container or container assembly 1. The container 1 includes a container body 10 configured to receive therein a food or beverage substance. In embodiments, the container body 10 sized to contain therein any edible substance whether liquid or solid. Examples of such container bodies include a cup, a can, a drink vessel, a mug, a conventionally know container that can contain an edible drinking substance, a food bowl, a soup bowl, a cereal bowl, and a conventionally know container that can contain an edible eating substance. In embodiments, a cover 40 can be utilized which can include a side 41 and a top 42 with or without a straw opening.

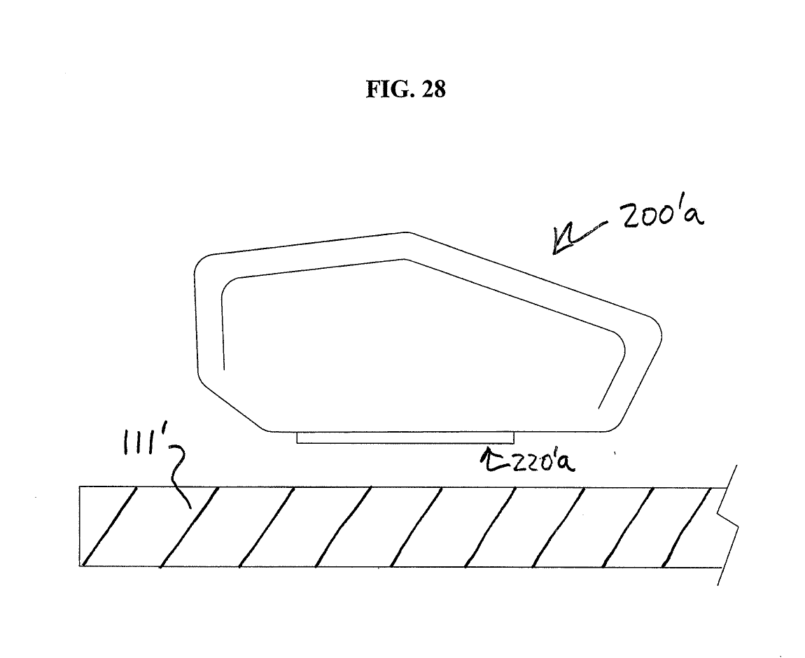

With reference to FIGS. 1-3, the container body 10 includes an outer wall 11, a bottom 12, a rim 13, an inner wall 14, an inner wall bottom 15, and a space arranged between the inner and outer walls. In this embodiment, the inner wall 14 comes into contact with the edible substance while the outer wall 11 does not, and can therefore include through openings as the connecting interfaces 18. The space 16 serves can serve a number of purposes such as an insulating function and providing an area for receiving the freed end of the connecting interface of each attachable element—which is described below. In this regard, the outer wall 11 can include one or more connecting interfaces 18 which allow the elements to be connected to the container body 10. As will be described in detail later on, the interfaces 18 can have numerous non-limiting forms, but preferably serve to allow a user to easily or conveniently connect one or more elements to the container body 10. However, according to at least one embodiment, an interface 18 need not be utilized (see embodiment of FIG. 28).

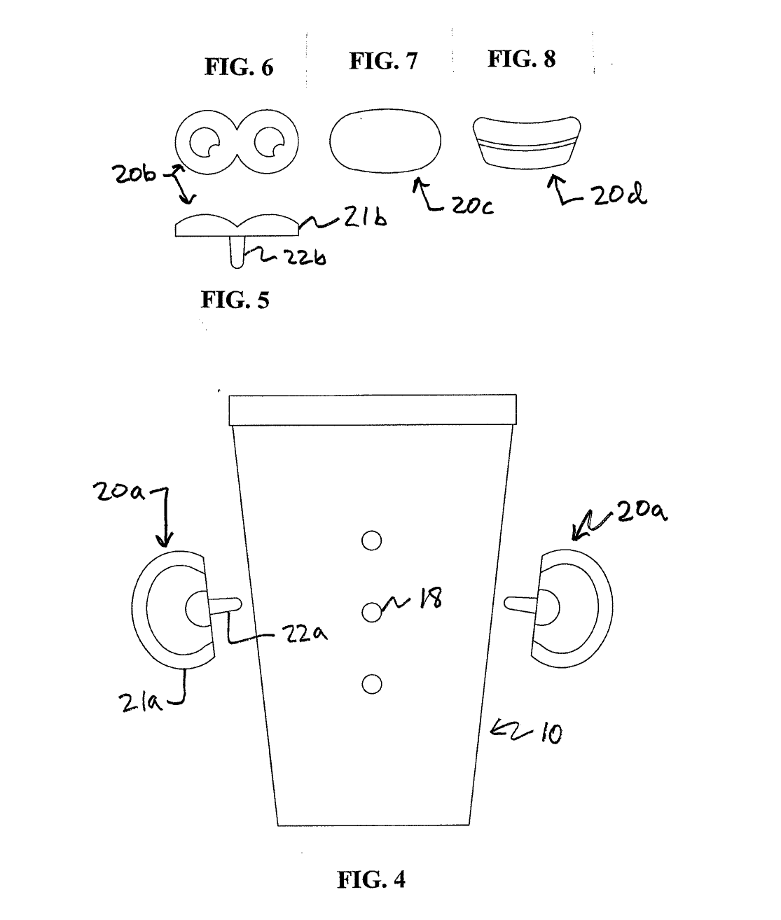

With reference to FIGS. 4-9, the container 1 can, in one exemplary embodiment, be made to resemble a head or life form with facial features or body parts. Exemplary attachable elements include an ear-shape element 20a having a body 21a and a connecting projection 22a, eye-shape element 20b having a body 21b and a connecting projection 22b, nose-shape element 20c having a body and a connecting projection, and a mouth-shape element 20d having a body and a connecting projection.

Starting with the container body 10 shown in FIG. 4, a user can begin decorating the container by attaching ear-shaped elements or objects 20a to the container body 10. In the embodiment of FIGS. 1-9, this occurs by the user inserting a connecting projection 22a of element 20a into an opening or recess 18 formed in the outer wall 11 so that it extends into the space 16. The configuration of the projection 22a and recess 18 is such that a frictional engagement occurs between these so that once inserted, the element 20a does not fall off and is retained on the container body 10 until the user grips the element 20a and pulls it off with a force sufficient to overcome the frictional engagement. In the embodiment of FIGS. 1-9, the frictional engagement is created by the projection 22a having a tapered configuration which is sized slightly larger than the opening 18 such that the more that the element 20a is pressed against the container body 10, the greater the frictional engagement. Once the ear-shaped elements 20a are attached, the user can attach the eye-shaped element 20b, the nose-shaped element 20c, and the mouth-shaped element 20d thereby creating the container 1 shown in FIG. 9 which resembles a head with facial features. Of course, the user can attach the elements 20a-20d in any desired order. Moreover, the arrangement, number and location of the openings 18 can be any configuration which allows a user to any number of elements or types of elements to the container body 10. In the embodiment, FIGS. 1-9, the container body 10 includes 12 openings 18, i.e., three openings 18 in four equally angularly spaced locations arranged around the wall 11. The openings 18 can be varied, standardized, or even customized to user needs or requirements without exceeding the scope of the invention.

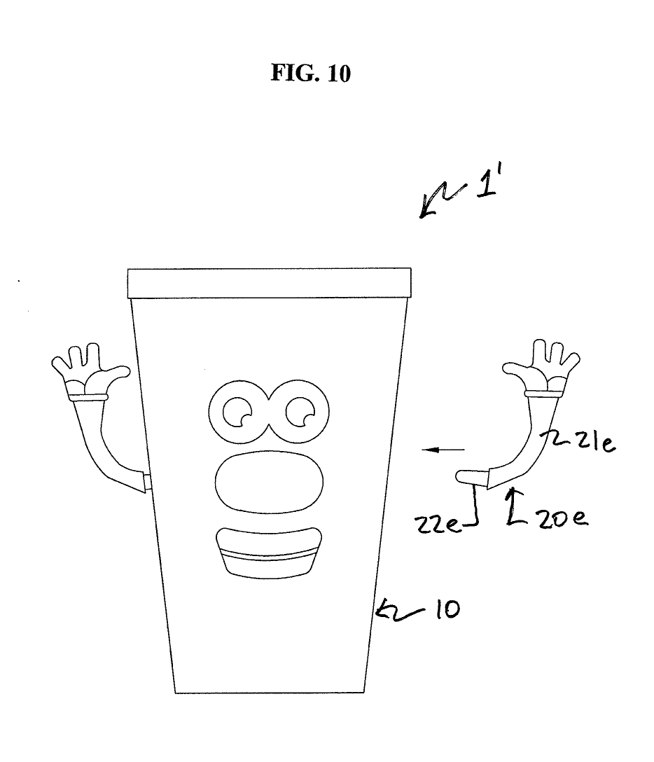

With reference to FIG. 10, the container 1′ can, in another exemplary embodiment, be made to resemble a human body with facial features and body parts. Exemplary attachable elements include arm-shape elements 20e having a body 21e and a connecting projection 22e, as well as elements from the previous embodiment, i.e., eye-shape element 20b having a body 21b and a connecting projection 22b, nose-shape element 20c having a body and a connecting projection, and a mouth-shape element 20d having a body and a connecting projection. As exemplified by this and the previous embodiment, the container body 10 can have a standard or predetermined pattern of openings 18 which allows the user flexibility to decorate the container in different ways. Such ways can even be suggested to the user in the packaging materials provided with the container.

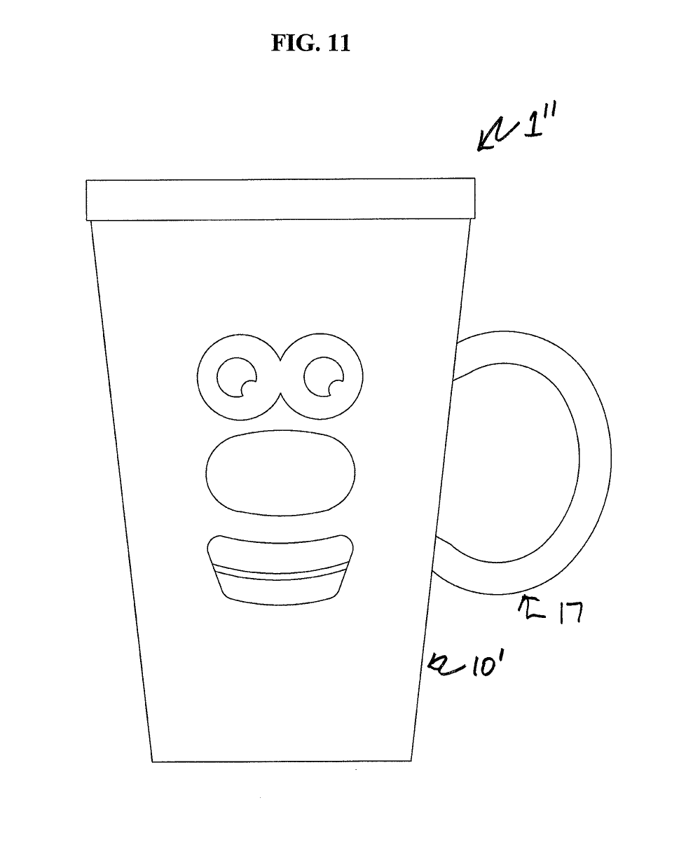

With reference to FIG. 11, the container 1″ can, in another exemplary embodiment, be made to resemble a human head with facial features and also include a handle 17 for allowing the user to pick-up the container 1″ without having to come into contact with the attachable elements.

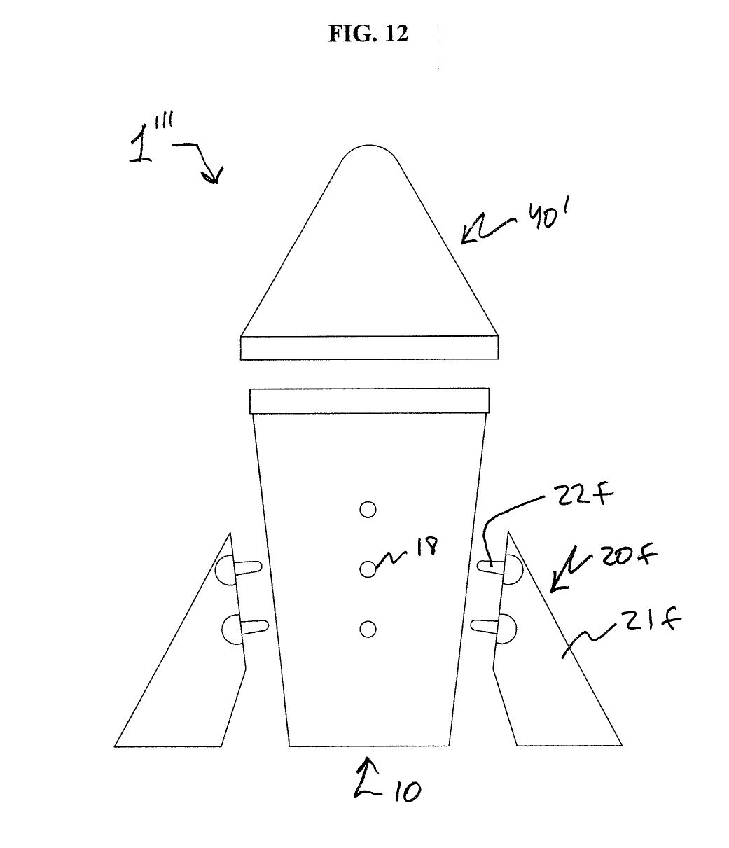

With reference to FIG. 12, the container 1′″ can, in another exemplary embodiment, be made to resemble an inanimate object like a rocket by attaching elements such as fins and a cone-shaped cover. Exemplary attachable elements include four side fins 20f (only two of which are shown) having a body 21f and plural connecting projections 22f. By suing two or more projections 22f, the elements 20f can be prevented from rotating relative to the container body 10 as might occur with only one projection. The rocket resembling container 1′″ can be capped-off (so-to-speak) with a cone-shaped cover 40′. If this cover 40′ is used with previously discussed embodiments, it can form a container resembling a “cone-head” alien life form made famous in TV and Hollywood.

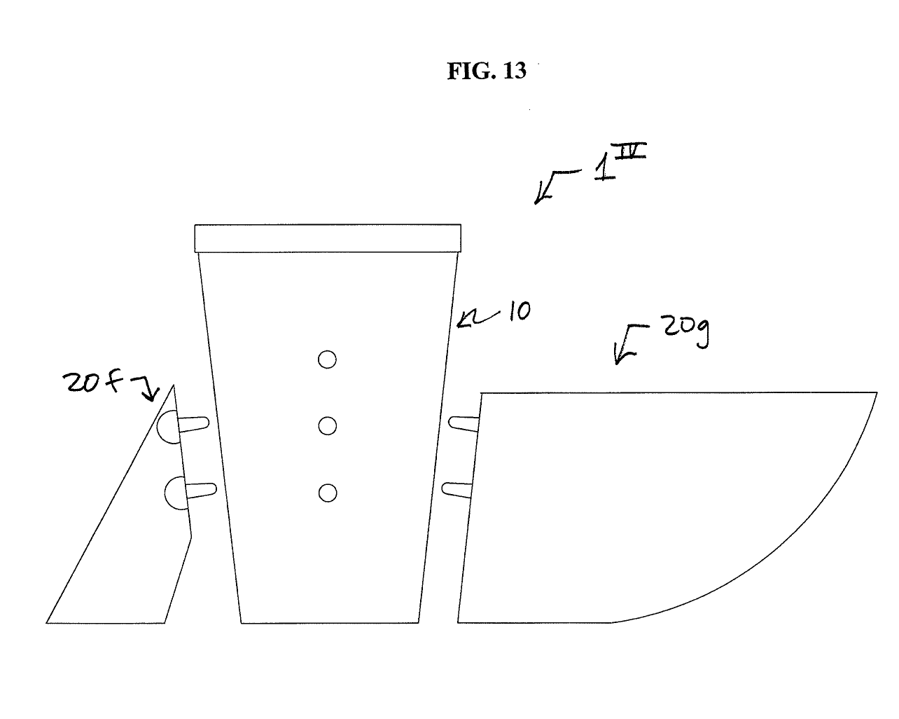

With reference to FIG. 13, the container 1^{IV} can, in another exemplary embodiment, be made to resemble an inanimate object like a boat by attaching elements such as a rudder and a bow-shaped element. Exemplary attachable elements include the fin 20f of the previous embodiment not resembling a rudder. The boat resembling container 1^{IV} can be finished with attaching a bow-shaped element 20g.

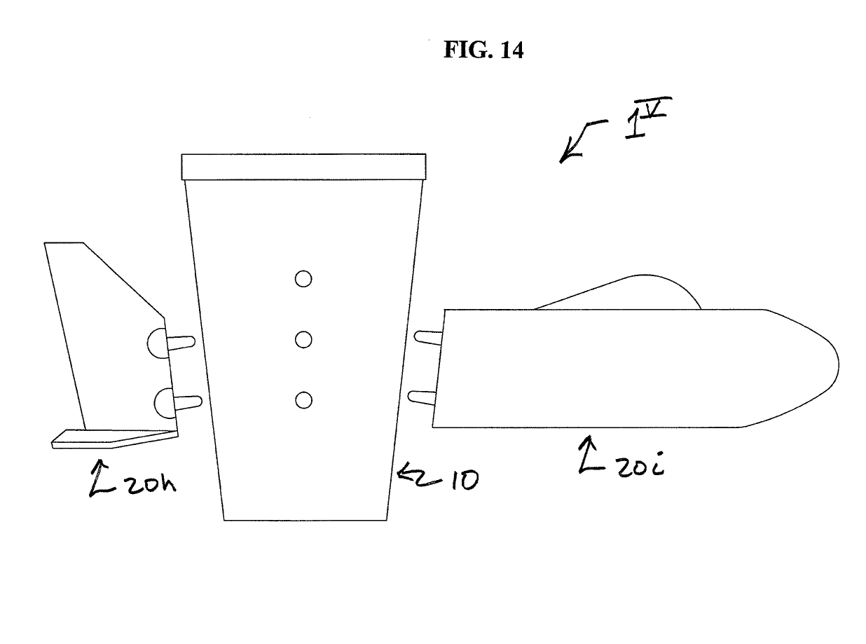

With reference to FIG. 14, the container 1^{V} can, in another exemplary embodiment, be made to resemble an inanimate object like an airplane by attaching elements such as a tail section shaped element and a nose-section shaped element. Exemplary attachable elements thus include the tail section element 20h and the nose-section element 20i. The airplane resembling container 1^{V}, like the previous inanimate object embodiments, illustrate how the same container body 10 can be made to resemble a large number of inanimate objects by removing and attaching various elements to the same.

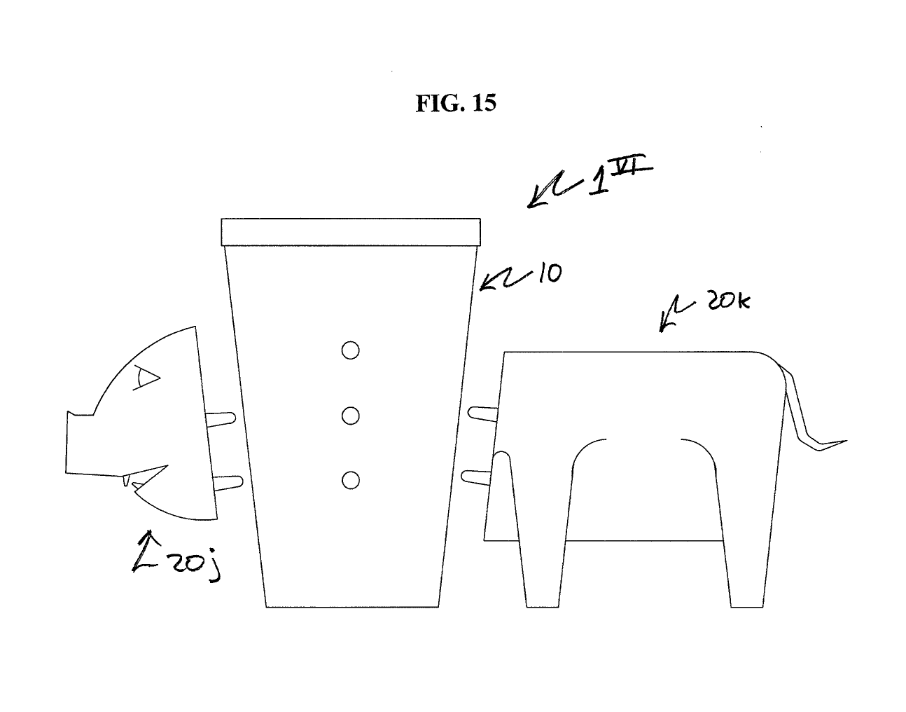

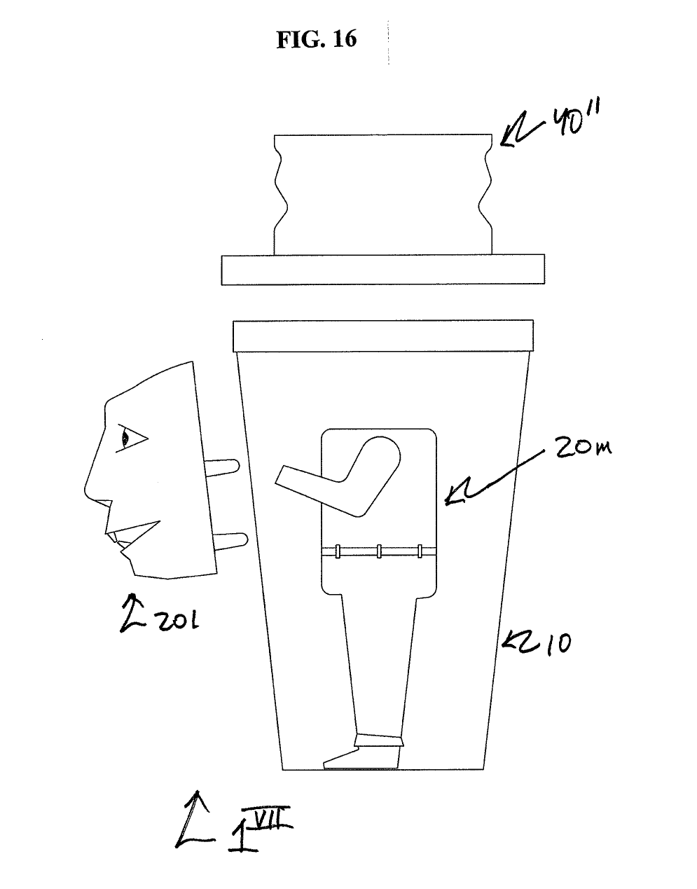

With reference to FIG. 15, the container 1^{VI} can, in another exemplary embodiment, be made to resemble a non-human animal life form like a pig by attaching elements such as a head-shaped element and a body shaped element. Exemplary attachable elements thus include the head-shaped element 20j and the body-shaped element 20k. The pig resembling container 1^{VI} should illustrate how the same container body 10 can be made to resemble a large number of animals by removing and attaching various elements to the same. Such animals include, among other things, a dinosaur, a bird, a lizard, etc. The possibilities are at least as large as the number of life forms currently known whether living today or now extinct.

With reference to FIG. 16, the container 1^{VII} can, in another exemplary embodiment, be made to resemble a human dressed (or wearing a uniform) for a particular occasion by attaching elements such as a head-shaped or face-shaped element, a dressed body shaped element and a hat-shaped cover 40″. Exemplary attachable elements thus include the head-shaped element 20l and the dressed or clothed body-shaped element 20m which show a leg, a torso, an arm, a pant leg and a shoe. The human resembling container 1^{VII} should illustrate how the same container body 10 can be made to resemble a large number of dressed humans by removing and attaching various elements to the same. Such dressed humans include, among other things, a farmer, Abraham Lincoln, a fireman, a pilot, a policeman, a soldier, etc. The possibilities are at least as large as the number of dress styles, uniforms, etc., currently known.

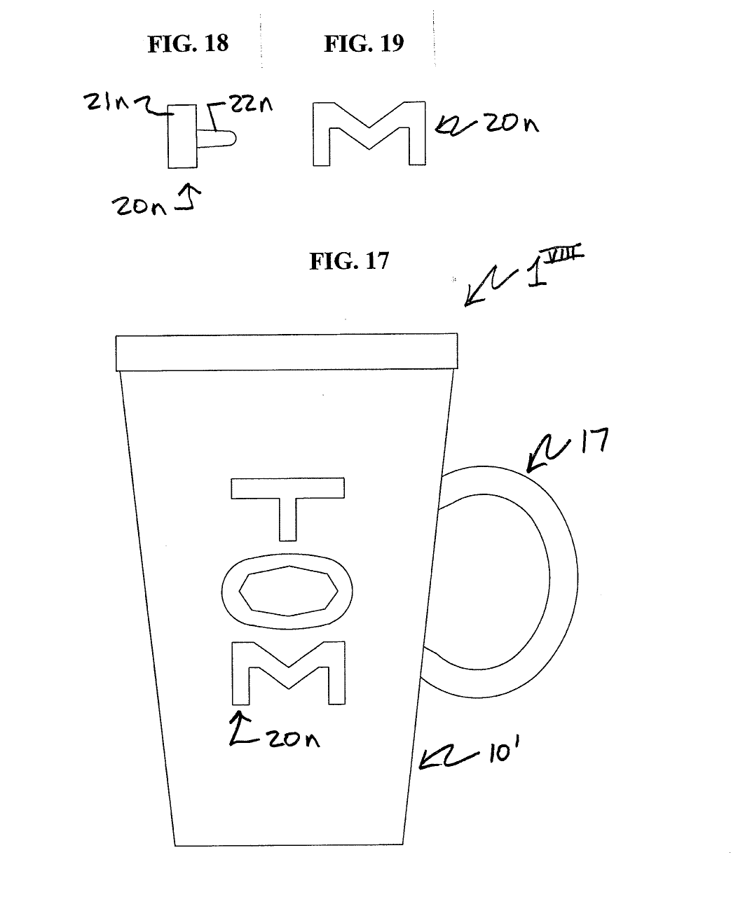

With reference to FIG. 17-19, the container 1^{VIII} can, in another exemplary embodiment, be made to resemble a container with a name, e.g., TOM, by attaching elements such as letters. A handle 17 can optionally be utilized on the container. Exemplary attachable elements thus include the letters of the alphabet such as the letters “T”, “O” and “M”. The M-shaped letter element 20n, for example, includes a body 21n and a projection 22n. The container 1^{VIII} should illustrate how the same container body 10′ can be made to have a large number names (or even numbers) by removing and attaching various elements, e.g., letters, numbers, etc., to the same. The possibilities are at least as large as the number of names, numbers, labels, symbols, acronyms, etc., currently known.

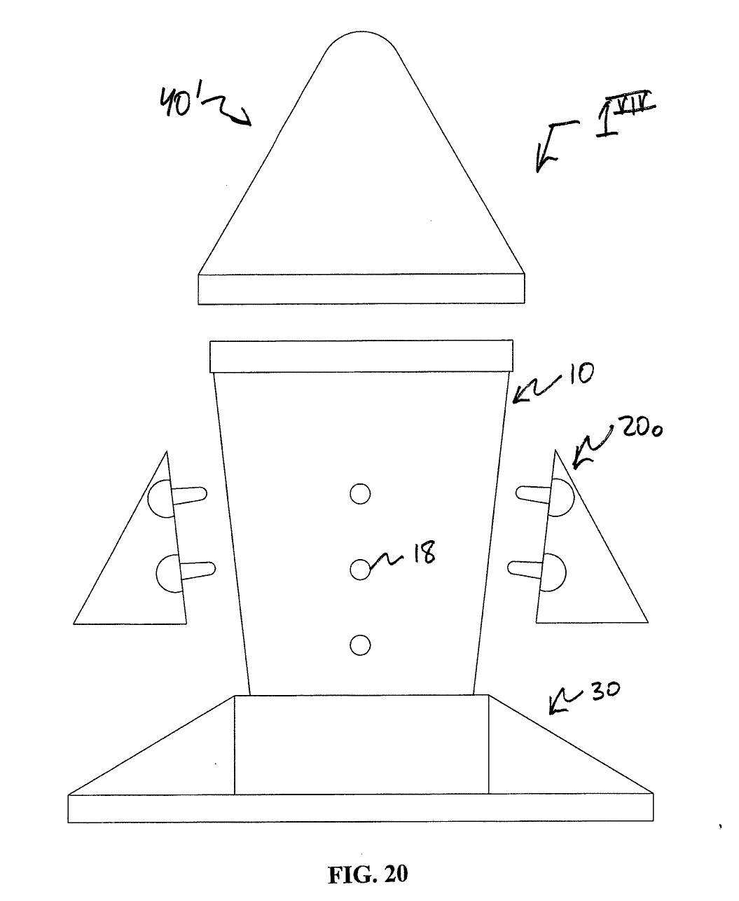

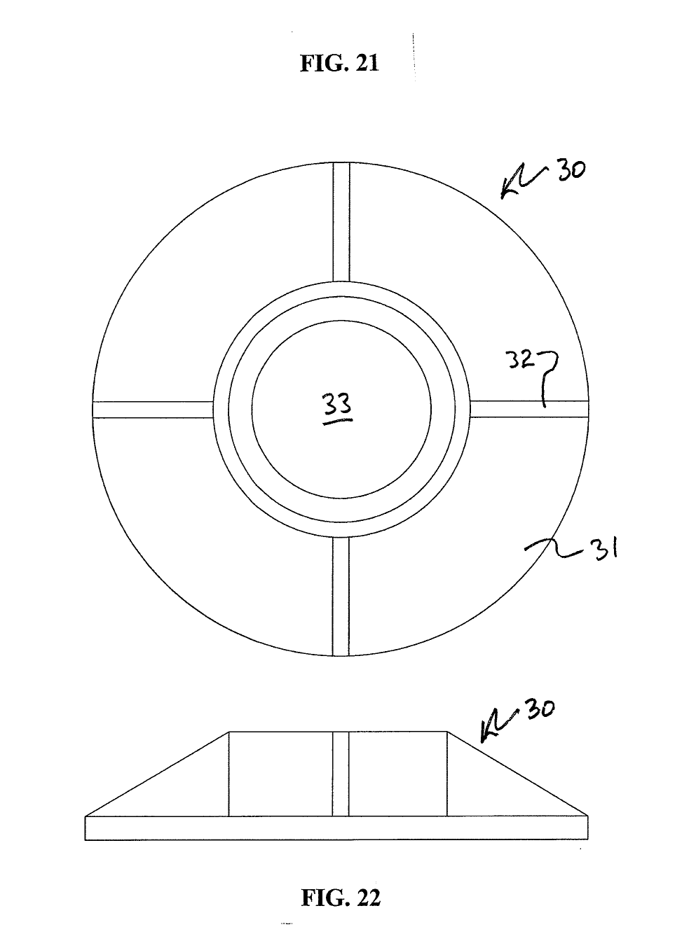

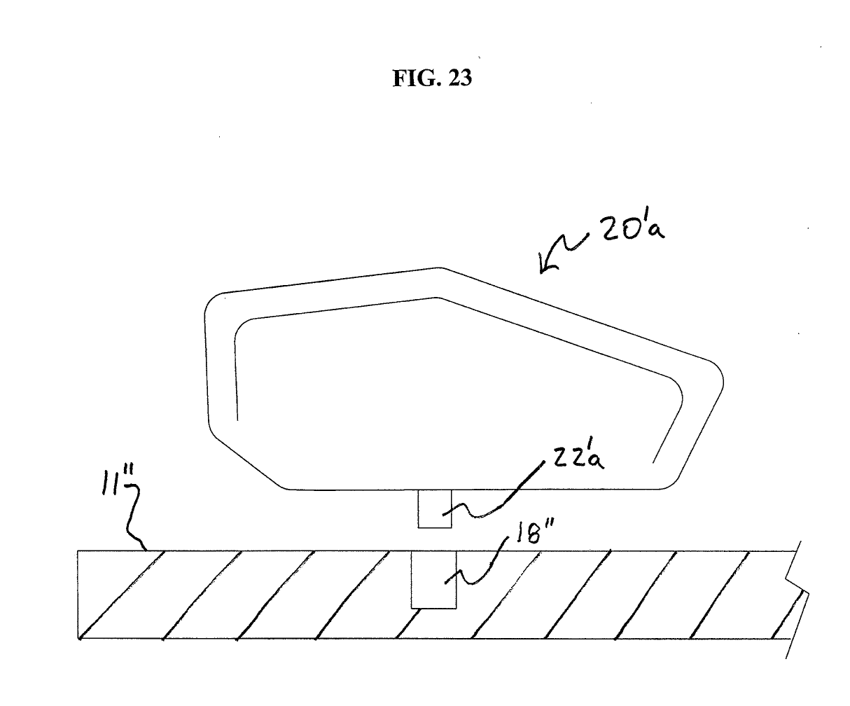

With reference to FIGS. 20-22, the container 1^{VIV} can, in another exemplary embodiment, be made to resemble an inanimate object like a rocket by attaching elements such as a fin base, side fins and a cone-shaped cover. Exemplary attachable elements include four side fins 20o (only two of which are shown). The rocket resembling container 1^{VIV} can be provided with a rocket-base shaped coaster 30 and is capped-off with a cone-shaped cover 40′. As can be seen in FIGS. 21 and 22, the coaster 30 includes a bottom wall 31, fins 32, and an inner space 33 sized to receive the container.

With reference to FIG. 23, there is shown another non-liming way of connecting attachable elements to a container body. In the embodiment of FIG. 23, this occurs by the user inserting a connecting projection 22′a of element 20′a into a blind opening or recess 18″ formed in the outer wall 11″. With such blind openings 18″, a dual-wall container of the type discussed above is not required and the container can be a single-wall container. The configuration of the projection 22′a and recess 18″ is such that a frictional engagement occurs between these so that once inserted, the element 20′a does not fall off and is retained on the wall 11″ of the container body until the user grips the element 20′a and pulls it off with a force sufficient to overcome the frictional engagement. In the embodiment of FIG. 23, the frictional engagement is created by the projection 22′a having a tapered configuration which is sized slightly larger than the opening 18″ such that the more that the element 20′a is pressed against the wall 11″, the greater the frictional engagement. As in the embodiment shown in FIG. 9, once the ear-shaped element 20′a is attached, the user can attach other elements such as, e.g., an eye-shaped element, the nose-shaped element, and the mouth-shaped element thereby creating a container similar to that shown in FIG. 9.

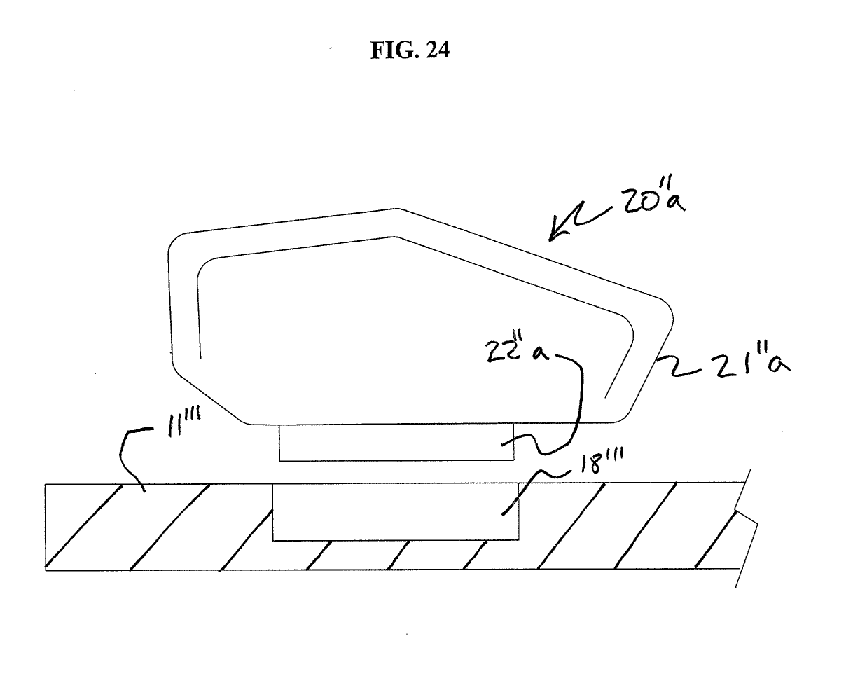

With reference to FIG. 24, there is shown another non-liming way of connecting attachable elements to a container body. In the embodiment of FIG. 24, this occurs by the user inserting an enlarged connecting portion 22″a of element 20″a into a blind enlarged opening or recess 18′″ formed in the outer wall 11′″. With such blind openings 18′″, a dual-wall container of the type discussed above is not required and the container can be a single-wall container. The configuration of the enlarged projection 22″a and recess 18′″ is such that a frictional engagement occurs between these so that once inserted, the element 20″a does not fall off and is retained on the wall 11′″ of the container body until the user grips the element 20″a and pulls it off with a force sufficient to overcome the frictional engagement. In the embodiment of FIG. 24, the frictional engagement is created by the projection 22″a having a tapered configuration which is sized slightly larger than the opening 18′″ such that the more that the element 20″a is pressed against the wall 11′″, the greater the frictional engagement.

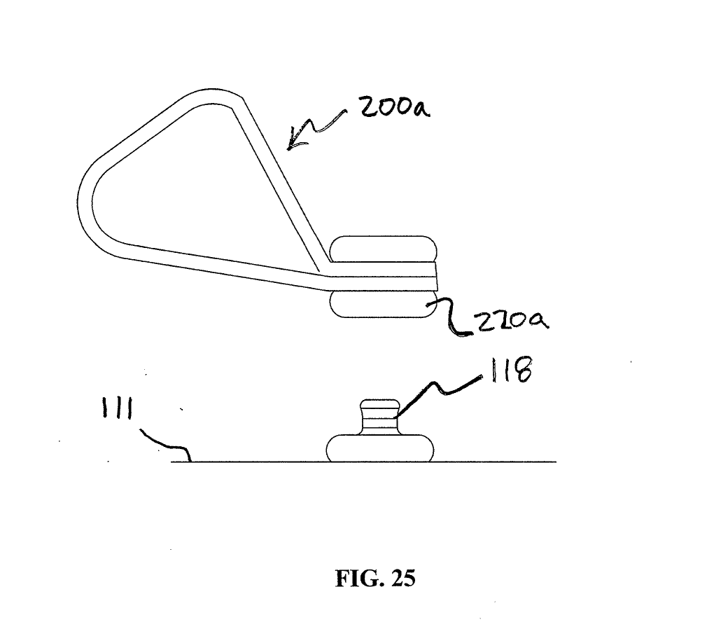

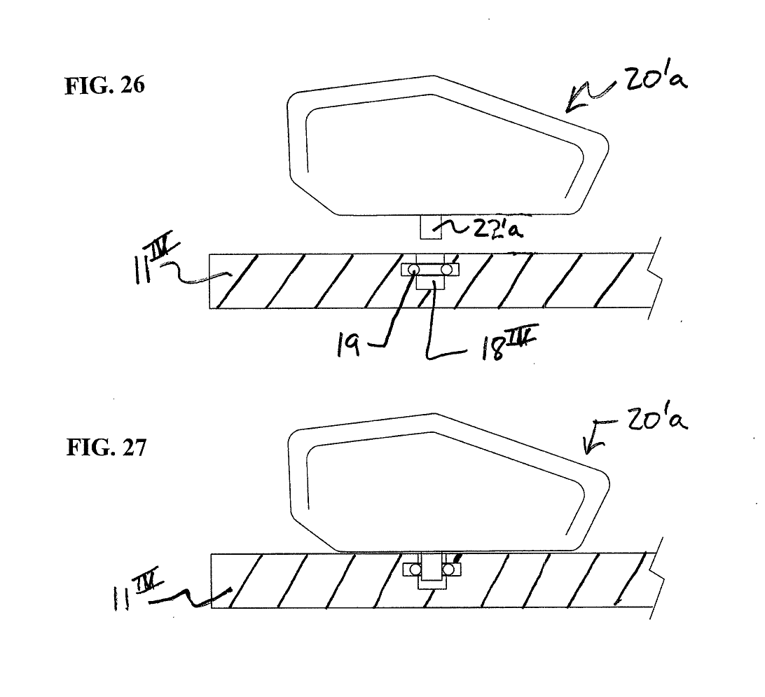

With reference to FIG. 25, there is shown another non-liming way of connecting attachable elements to a container body. In the embodiment of FIG. 25, this occurs a snap-connection, i.e., via an snap receiver 220a of element 200a releasably engaging with a snap projection 118 arranged on the outer wall 111. The snap projection 118 can be attached to the wall 111 via adhesive or other mechanism such as ultrasonic welding. With such an arrangement, a dual-wall container of the type discussed above is not required and the container can be a single-wall container. The snap-connection can otherwise be of any conventional type. Although not shown, the invention contemplates using the snap projection of the attachable element and the snap receiver on the wall 111.

With reference to FIGS. 26 and 27, there is shown another non-liming way of connecting attachable elements to a container body. In the embodiment of FIGS. 26 and 27, this occurs by the user inserting a connecting portion 22′a of element 20′a into a blind enlarged opening or recess 18^{IV} formed in the outer wall 11^{IV}. The recess 18^{IV} includes a radially and/or elastically expandable ring 19 which can frictionally engage with the projection 22′a. Such an arrangement can also be utilized on single-wall container. The configuration of the projection 22″a and recess 18^{IV} is such that a releasable frictional engagement occurs between these so that once inserted, the element 20″a does not fall off and is retained on the wall 11^{IV} of the container body until the user grips the element 20″a and pulls it off with a force sufficient to overcome the frictional engagement. In the embodiment of FIGS. 26 and 27, the frictional engagement is created by the projection 22″a without requiring a tapered configuration which is sized slightly larger than the opening 19 and results in a set or predetermined frictional engagement.

With reference to FIG. 28, there is shown another non-liming way of connecting attachable elements to a container body. In the embodiment of FIG. 28, attachment occurs by the user simply placing a magnetic connecting portion 220′a of an attachable element, e.g., element 200′a, adjacent a metal surface of the wall 111′. No recess or other connecting interfaces are required to be arranged on the wall 111′. Instead, the wall 111′ can be made of metal or can have metal embedded in the wall or layered on the wall. The magnetic connecting portion 220′a can be in the form of a layer of magnetic material that is attached to the attachable element via, e.g., an adhesive. In embodiments, the magnetic connecting portion 220′a can be embedded or recessed into the element 200′a (not shown) so that it is not readily visible. In embodiments, the element itself can be made magnetic (not shown).

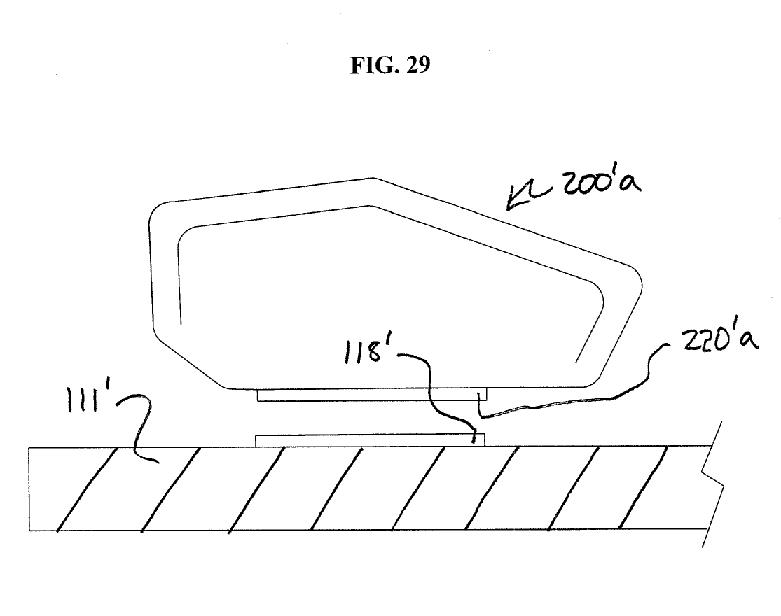

With reference to FIG. 29, there is shown another non-liming way of connecting attachable elements to a container body. In the embodiment of FIG. 29, attachment occurs by the user simply placing a magnetic connecting portion 220′a of an attachable element, e.g., element 200′a, adjacent another similar magnetic connecting portion 118′ arranged on the wall 111′. In embodiments, the wall 111′ can be made of a metal and can have portion 118′ magnetically attached to the wall. The magnetic connecting portion 118′ can be in the form of a layer of magnetic material that is attached to the wall 118′ via, e.g., an adhesive. In embodiments, the magnetic connecting portion 118′ can be embedded or recessed into the wall 111′ (not shown) so that it is not readily visible.

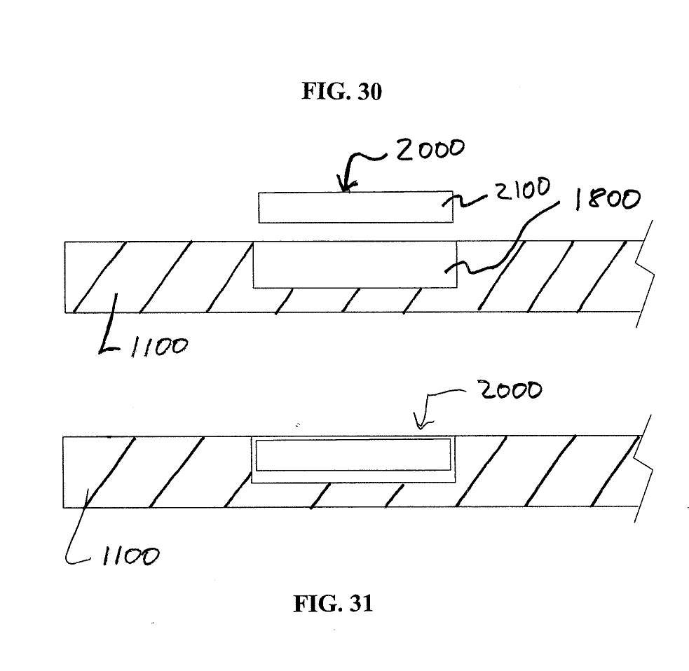

With reference to FIGS. 30 and 31, there is shown another non-liming way of connecting attachable elements to a container body. In the embodiment of FIGS. 30 and 31, attachment occurs by the user simply placing an attachable element, e.g., element 2000, within a similarly sized recess 1800 arranged on or formed in the wall 1100. In this embodiment, the element 2000 has a body portion 2100 and includes a two-dimensional picture of an object on its outer surface (not shown). This picture can be similar to any of the three-dimensional objects described herein, for example. In embodiments, the wall 1100 can be made of a metal and the body 2100 can be made magnetic so that it is retained within the recess 1800 via magnetism. In embodiments, the element 2000 can be of any shape such as circular, square, triangular, etc., and can simply be snugly fit into the generally comparably shaped recess 1800 so as to be retained therein via frictional engagement.

One or more features of one embodiment may be utilized in one or more other embodiments. The container body and cover can be made of any materials typically used for containers of edible substances and includes synthetic resins, metals, foams, paper products, etc. The attachable elements can also be made of any of these materials including those disclosed in the herein expressly incorporated documents. Preferably, materials used for each of these features is dishwasher and/or microwave safe. Furthermore, although certain types of releasable connections are herein disclosed, the invention also contemplates other types of connections such as, e.g., lego-type and hook and loop, etc.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A food or beverage container comprising:
a container body sized to contain therein an edible substance or drinkable substance; and
at least one of:
at least one three-dimensional element attachable to the body of the container;
at least one image of an object attachable to the body of the container;
at least one image of a facial feature attachable to the body of the container;
at least one image of body part attachable to the body of the container;
at least one body part attachable to the body of the container;
at least one body part removably attachable to the body of the container;
at least one facial feature attachable to the body of the container; and
at least one facial feature removably attachable to the body of the container.

2. The container of claim 1, wherein the container is one of:
a cup;
a can;
a drink vessel;
a mug; and
a conventionally know container that can contain an edible drinking substance.

3. The container of claim 1, wherein the container is one of:
a food bowl;
a soup bowl;
a cereal bowl; and
a conventionally know container that can contain an edible eating substance.

4. The container of claim 1, wherein the at least one body part is one of:
an arm;
a hand;
a finger;
a leg;
a foot;
a toe; and
an object resembling a portion of one of an arm, a hand, a finger, a leg, a foot and a toe.

5. The container of claim 1, wherein the at least one facial feature is one of:
an eye;
eyes;
a nose;
an ear;
ears;
a mouth; and
an object resembling a portion of one of an eye, eyes, a nose, an ear, ears and a mouth.

6. The container of claim 1, wherein the at least one three-dimensional element is one of:
a letter;
a number;
an inanimate object;
an object resembling an inanimate object.

7. The container of claim 1, wherein the at least one three-dimensional element is one of:
a head of an animal;
a face of an animal;
a body of an animal;
a portion of an animal.

8. The container of claim 1, wherein the at least one body part is attachable via one of:
a snap connection;
a projection insertable into an opening; and
a magnet.

9. The container of claim 1, wherein the at least one facial feature is attachable via one of:
a snap connection;
a projection insertable into an opening;
a magnetic;
a releasable connection; and
a lockable connection.

10. A container comprising:
a container body sized to contain therein an edible substance; and
plural elements attachable to the body of the container,
wherein, once attached, the container at least partially resembles one of:
an inamate object; and
a life form.

11. The container of claim 10, wherein the container is one of:
a cup;
a can;
a drink vessel; and
a mug.

12. The container of claim 10, wherein the container is one of:
a food bowl;
a soup bowl; and
a cereal bowl.

13. The container of claim 10, wherein at least one of the elements is one of:
an arm;
a hand;
a finger;
a leg;
a foot;
a toe;
an eye;
eyes;
a nose;
an ear;
ears;
a mouth;
a letter;
a number;
an inanimate object; and
an object resembling an inanimate object.

14. A container comprising:
a container body sized to contain therein an edible substance; and
plural facial or body features attachable to the body of the container,
wherein, once attached, the container at least partially resembles a life form.

15. The container of claim 14, wherein the container is one of:
a cup;
a can;
a drink vessel;
a mug;
a food bowl;
a soup bowl; and
a cereal bowl.

16. A method of decorating the container of claim 1, the method comprising:
attaching at least one element to the body of the container.

17. A method of decorating the container of claim 1, the method comprising:
removably attaching at least one element to the body of the container.

18. A method of decorating the container of claim 1, the method comprising:
attaching at least one element to the body of the container; and
attaching at least one other different element to the body of the container,
wherein, after the attaching, the container resembles an inanimate object.

19. A method of decorating the container of claim 1, the method comprising:
attaching at least one element to the body of the container; and
attaching at least one other different element to the body of the container,
wherein, after the attaching, the container resembles a life form.

20. A method of making the container of claim 1, the method comprising at least one of:
forming a container body to which at least one element can be attached;
manufacturing a container body to which at least one element can be removably attached;
arranging at least one connecting arrangement on a container body to which at least one element can be attached.
